(19) United States
(12) Patent Application Publication
(10) Pub. No.: US 2024/0126077 A1
(43) Pub. Date: Apr. 18, 2024

(54) OPTICAL ASSEMBLY AND HEAD-UP DISPLAY HAVING A PLURALITY OF IMAGE PLANES

(71) Applicant: Carl Zeiss Jena GmbH, Jena (DE)

(72) Inventors: Yi Zhong-Schipp, Jena (DE); Siemen Kühl, Jena (DE); Xiang Lu, Jena (DE); Marc Junghans, Jena (DE)

(21) Appl. No.: 18/395,278

(22) Filed: Dec. 22, 2023

Related U.S. Application Data
(63) Continuation of application No. PCT/EP2022/066787, filed on Jun. 21, 2022.

(30) Foreign Application Priority Data
Jun. 22, 2021 (DE) 10 2021 116 146.0

(51) Int. Cl. G02B 27/01

(52) U.S. Cl. CPC G02B 27/0103; G02B 2027/0185

(57) ABSTRACT

An optical assembly for a head-up display on a projection surface includes an imaging device, which includes at least one imaging unit, and at least one wavefront manipulator arranged in a beam path between the imaging device and the projection surface. The optical assembly is configured to generate virtual depictions in at least two different image planes, wherein the imaging device has at least a first region and a second region, wherein the imaging device and the wavefront manipulator are configured, in combination, to generate virtual depictions in a first image plane out of images generated in the first region of the imaging device and to generate virtual depictions in a second image plane out of images generated in the second region of the imaging device.

### CROSS REFERENCE TO RELATED APPLICATIONS

This application is a continuation application of international patent application PCT/EP2022/066787, filed Jun. 21, 2022, designating the United States and claiming priority to German application DE 10 2021 116 146.0, filed Jun. 22, 2021, and the entire content of both applications is incorporated herein by reference.

### TECHNICAL FIELD

The present disclosure relates to an optical arrangement for a head-up display (HUD) and to a head-up display.

### BACKGROUND

Head-up displays are now being used in the context of diverse applications, inter alia also in association with observation windows of vehicles, for example on windshields of motor vehicles, front screens or observation windows of aircraft. These viewing windows, and in particular windshields, usually have a curved surface which is used as a projection surface of head-up displays.

A head-up display usually includes a picture generating unit (PGU) or a projector, a projection surface, an eyebox and a virtual image plane. An image is generated in a picture generator plane with the picture generating unit or the projector. The image is projected onto the projection surface and is projected from the projection surface into the eyebox. The eyebox is a plane or a spatial region in which the projected image is perceptible to a viewer as a virtual image. The virtual image plane, which is to say the plane on which the virtual image is generated, is arranged on or behind the projection surface.

Conventional HUD systems have only one image plane and only one picture generator plane (see FIG. 1). On account of the demands placed on future HUD systems by the market, it is necessary to realize more than an image plane with different image distances in the HUD. To reduce the costs and maintain the stability of the system, it is necessary for the components in the HUD to be fixedly installed where possible and for movable parts to be dispensed with. At the same time, there should not be a substantial increase in terms of installation space demands.

### SUMMARY

Against this background, it is an object of the present disclosure to provide an advantageous optical arrangement for a head-up display on a projection surface and an advantageous head-up display, which in particular enable the generation of virtual images in different image planes.

The object is achieved by an optical arrangement for a head-up display and by a head-up display as described herein.

The optical arrangement according to an aspect of the disclosure for a head-up display on a projection surface includes a picture generating device and at least a wavefront manipulator arranged in the beam path between the picture generating device and the projection surface. The picture generating device includes at least one picture generating unit. The optical arrangement according to the aspect the disclosure is configured to generate virtual images in at least two different image planes, which is to say image planes at different image distances. In the present context, the image distance is the distance between the image plane of the virtual image and the eyebox.

To generate at least two different image planes, the picture generating device has at least a first region and a second region. In combination with one another, the picture generating device and the wavefront manipulator are configured to generate virtual images in a first image plane from pictures generated in the first region of the picture generating device and to generate virtual images in a second image plane from pictures generated in the second region of the picture generating device. In other words, the at least two different or deviating image planes are located at deviating distances from the eyebox or from the projection surface along the optical axis.

The optical arrangement according to an aspect of the disclosure is advantageous in that a plurality of image planes with different image distances can be realized in the head-up display. In the process, the components required to this end can be securely installed in the head-up display. Thus, no movable parts are required. This enables a robust optical arrangement and hence a correspondingly robust head-up display. Moreover, an optical arrangement according to an aspect of the disclosure can be produced cost-effectively and existing head-up displays can optionally be retrofitted with little outlay.

The first region and the second region of the picture generating device may have a common picture generator plane. In other words, the picture generating device can thus have only a single picture generating unit or component, which only has one for example segmented picture generator plane. In an alternative, the first region of the picture generating device may have a first picture generator plane and the second region of the picture generating device may have a second picture generator plane. In this variant, the first picture generator plane and the second picture generator plane may differ from one another. In particular, for example two different components or picture generating units may be present, which are arranged at a deviating distance from the wavefront manipulator. This variant is particularly suitable for retrofitting existing head-up displays with a further picture generating apparatus or unit and thus realizing a plurality of image planes with different image distances in the head-up display.

The at least one wavefront manipulator typically includes at least one holographic arrangement. The at least one holographic arrangement is typically configured to diffract light at a plurality of wavelengths. For this purpose, multiple holograms, each of which diffracts light at one wavelength, and/or multiplex holograms, which diffract light at a plurality of wavelengths, can be arranged as hologram stacks. In addition or as an alternative, the at least one wavefront manipulator includes at least one optical element which has a free-form surface. Advantageously, the optical element having a free-form surface is arranged in the beam path between the picture generating device and the holographic arrangement. A plurality of free-form surfaces may be present, for example in the form of a plurality of corresponding optical elements or one optical element having a plurality of free-form surfaces. The individual free-form surfaces can each be configured for the beam shaping of light emitted from a specific region of the picture generating device and/or a specific picture generating unit. For example, a first picture generating unit or a first region and a first free-form surface arranged in the beam path of the light emitted from said first picture generating unit or first region and a second picture generating unit or a second region and a second free-form surface arranged in the beam path of the light emitted from said second picture generating unit or second region may be present.

At least a holographic arrangement and/or a further free-form element can realize an advantageous wavefront manipulator within little installation space, said wavefront manipulator inter alia correcting arising picture errors or aberrations. In particular, imaging aberrations such as distortion, defocus, tilt, astigmatism, curvature of the image plane, spherical aberrations, higher-order astigmatism and coma, etc., can be corrected with the aid of holographic elements and/or free-form surfaces. The optical element including the free-form surface contributes to an improvement in the resolution by way of a corresponding configuration of the free-form surface and allows a targeted correction of imaging aberrations. Furthermore, the optical element takes up only very little installation space on account of the free-form surface. In other words, it also makes a considerable contribution to an improvement in the imaging quality of a head-up display having a compact configuration.

A free-form surface should be understood in the broader sense to mean a complex surface that can be represented, in particular, with regionally defined functions, in particular twice continuously differentiable regionally defined functions. Examples of suitable regionally defined functions are (in particular piecewise) polynomial functions (in particular polynomial splines, such as for example bicubic splines, higher-degree splines of the fourth degree or higher, or polynomial non-uniform rational B-splines (NURBS)). These should be distinguished from simple surfaces, such as for example spherical surfaces, aspherical surfaces, cylindrical surfaces, and toric surfaces, which are described as a circle, at least along a principal meridian. In particular, a free-form surface need not have axial symmetry and need not have point symmetry and can have different values for the mean surface power value in different regions of the surface.

In an advantageous variant, the wavefront manipulator includes at least a first holographic arrangement and a second holographic arrangement, with the first holographic arrangement being configured to generate virtual images in the first image plane from pictures generated in the first region of the picture generating device and the second holographic arrangement being configured to generate virtual images in the second image plane from pictures generated in the second region of the picture generating device. In this way, a head-up display having a plurality of image planes with different image distances can be realized without additionally requiring installation space, purely by way of a suitable configuration of a plurality of holographic arrangements.

In particular, the first holographic arrangement can be configured to diffract light at at least a first wavelength. For example, the first holographic arrangement can be configured to diffract light at three different wavelengths in a defined color space. The second holographic arrangement can be configured to diffract light at at least a second wavelength. For example, the second holographic arrangement can be configured to diffract light at three wavelengths in a defined color space, but these wavelengths differ from the wavelengths for which the first holographic arrangement is configured. In this case, the difference between the first and the second wavelength must exceed a defined limit value. For example, the first holographic arrangement may be configured to diffract red light at a first wavelength and the second holographic arrangement may be configured to diffract red light at a second wavelength that differs slightly from the first wavelength. For example, the two wavelengths of red light may differ from one another by at least 10 nanometers or at least 20 nanometers. Analogously, the first holographic arrangement and the second holographic arrangement may be configured to diffract green and blue light at defined wavelengths, with the wavelengths of the individual colors, for which the holographic arrangements are configured, once again differing by a defined absolute difference value.

The holographic arrangement and/or the at least one optical element including a free-form surface can each be configured to be reflective and/or transmissive. This enables the implementation of variable beam paths, in particular folded beam paths, in little installation space. A reflective configuration of the optical element having the free-form surface is particularly advantageous in association with an application for head-up displays having a compact configuration since, in this way, the optical element can simultaneously contribute to a beam deflection that is necessary anyway, even at high angles of incidence, without in the process inducing additional image errors such as chromatic aberrations, in particular.

Typically, the free-form surface is configured to at least partly correct at least one aberration or one imaging aberration. That can be at least one of the aforementioned imaging aberrations. The imaging aberration(s) can be caused by the projection surface, in particular in the case of a curved projection surface, and/or can be caused by the picture generating unit and/or by the geometry of the beam path, for example in the context of a head-up display. Furthermore, the resolution and thus the imaging quality can be optimized with the free-form surface.

Typically, the free-form surface has a surface geometry which is derived from an imaging function dependent on at least one defined parameter. The at least one defined parameter can arise from an envisaged application of the wavefront manipulator. For example, the radius of curvature of a windshield can be used as a parameter that influences the shape of the free-form surface. The optical element can have a plurality of free-form surfaces, in particular in order to be able to perform corrections of aberrations adapted to the respective application geometry. In the context of an application in motor vehicles, for example, this makes it possible to use a uniform wavefront manipulator which can be adapted to the specific geometry of the windshield present by way of the specific selection or arrangement of the free-form surfaces used.

Advantageous properties and features of a holographic arrangement which can be used within the scope of the present disclosure are described below.

The holographic arrangement may include at least two holographic elements. The at least two holographic elements are typically arranged directly in succession in the beam path. In other words, no further optical element or component is arranged between the at least two holographic elements. Moreover, the at least two holographic elements can be configured to be reflective for at least a defined wavelength and a defined angle of incidence range. Otherwise the holographic elements typically have a transmissive design.

The use of two holographic elements arranged directly in succession and configured to be at least partly reflective has the advantage that in particular in association with a head-up display, the imaging quality can be considerably improved by way of the individual configuration of the holographic elements. For this purpose, the holographic elements take up almost no installation space, and so when there is only little available installation space, such as in the case of a head-up display configured for a motor vehicle, for example, a significant increase in the imaging quality can be achieved with the wavefront manipulator. The holographic arrangement achieves a high refractive power, in particular, comparable with the refractive power such as is achieved for example by an optical component configured to be transmissive without chromatic aberration. Compared with transmission holograms, reflective holograms for a defined wavelength offer a broader angular spectrum with a high efficiency and a higher wavelength selectivity. As a result, the color channels can be separated from one another despite a broad angle of incidence spectrum. The holographic arrangement thus enables a large field of view (FOV) with high efficiency at the same time and is thus suitable both for VR head-up displays (VR—Virtual Reality) and augmented reality head-up displays (AR HUDs) with a large field of view and a large numerical aperture. Further application possibilities are afforded by head-up displays having curved projection surfaces, for example head-up displays for windshields of vehicles, in particular motor vehicles, rail vehicles, aircraft or ships, and generally for observation windows.

A further advantage achieved by the holographic arrangement is that, on account of the high diffraction angle of the holographic arrangement, the proportion of the light from unused orders of diffraction which is reflected into the eyebox is reduced. Furthermore, high-quality multicolored image representations can be generated.

Typically, each of the at least two holographic elements includes a plurality of holograms. In this case, each hologram is recorded or generated with at least one defined wavelength. A holographic element can include a plurality of holograms, for example, which can be arranged one on top of another as a stack. By way of example, a holographic element can have a plurality, of monochromatic holograms. In an alternative, a holographic element can include at least one hologram which is recorded or generated with at least two defined wavelengths. Typically, such a hologram is recorded with three different wavelengths of a defined color space, for example is configured as an RGB hologram or a CMY hologram or as a hologram formed from a plurality of individual wavelengths of a different color space. In the examples mentioned, R stands for Red, G stands for Green, B stands for Blue, C stands for Cyan, M stands for Magenta, and Y stands for Yellow.

Therefore, at least one, typically two, of the at least two holographic elements can include at least two, typically three, holograms which are configured to be reflective for mutually different wavelengths. In addition or an alternative, at least one, typically two, of the at least two holographic elements can include at least one hologram which is configured to be reflective for at least two, typically three, mutually different wavelengths. In other words, the holograms mentioned have been recorded with correspondingly mutually different wavelengths.

The arrangement of the individual holograms of a holographic element or of the totality of the holograms of the holographic arrangement can be used as a degree of freedom in order to avoid filter effects between the holograms. The individual, mutually differing holograms of a holographic element can be arranged next to one another and/or one behind another in relation to a center line or center axis, which can coincide with the optical axis, or in relation to some other defined geometric parameter of the holographic element.

The holographic arrangement can include a first holographic element and a second holographic element, a plurality of the holograms or all of the holograms of the respective holographic element being configured identically or the same, with the exception of the wavelength for which they are configured. In other words, a plurality or all of the holograms of the first holographic element can be configured identically and can differ from one another only in regard to the wavelength for which they are configured. Analogously, a plurality or all of the holograms of the second holographic element can be configured identically and can differ from one another only in regard to the wavelength for which they are configured.

Typically, the first holographic element is arranged mirror-symmetrically with respect to the second holographic element in relation to the arrangement of the individual holograms. For example, the first holographic element can include a hologram recorded with red light, a hologram recorded with green light and a hologram recorded with blue light, which are arranged one on top of another in the order mentioned. The second holographic element can likewise have a hologram recorded with red light, a hologram recorded with green light and a hologram recorded with blue light, which are likewise arranged one on top of another in this order. In the case of a mirror-symmetrical arrangement, the first holographic element and the second holographic element are arranged one on top of another or adjacent to one another in such a way that for example the hologram of the first holographic element recorded with red light is arranged directly adjacent to the hologram of the second holographic element recorded with red light. In an alternative, the arrangement of the holograms of the first holographic element can be identical to the arrangement of the holograms of the second holographic element in relation to a defined direction. For example, both holographic elements can have holograms arranged in the order RGB (R—hologram recorded with red light, G—hologram recorded with green light, B—hologram recorded with blue light) in relation to a defined direction, which are arranged against one another in such a way that the hologram R of one holographic element adjoins the hologram B of the other holographic element. Any other mutually different arrangements are likewise possible, for example RGB adjoining or adjacent to GBR etc.

In a further advantageous variant, a plurality of the holograms of at least one of the holographic elements are recorded with two design wavefronts. Of the latter, at least one design wavefront of at least one hologram of the holographic elements is identical to at least one design wavefront of another hologram of one of the holographic elements, in particular of the first and/or of the second holographic element, with regard to the wavelength and the angle of incidence. The use of identical design wavefronts for different wavelengths has the advantage that the required holograms can be produced with little outlay and high precision.

The jointly used design wavefront is typically defined as a plane wave which leads to a minimal filter effect between different wavelengths and additionally has the advantage that positioning tolerances of the holograms assigned to a color with respect to one another can be chosen more generously compared with the use of a non-plane wave. In other words, varying distances between the holograms in the direction of the optical axis and/or in a lateral direction, which is to say perpendicular to the optical axis, are possible without an adverse effect on the imaging quality.

The holographic arrangement, in particular at least one of the holographic elements, is typically configured such that it transforms a spherical wave into a plane wave. As a result, the holographic arrangement, in particular the holographic element, has a high refractive power, without the volume and thus the required installation space being increased. Furthermore, the beam cross section on the mirror decreases, as a result of which both the size and the refractive power of the mirror can be reduced. This is additionally advantageous since the refractive powers can be better distributed in the system and the latter becomes less sensitive to tolerances. Furthermore, at least one of the holographic elements can be configured such that it transforms a free-form wavefront into a plane wavefront or transforms a spherical wave into a free-form wavefront. At least one hologram can be recorded or exposed with waves with at least one free-form wave. As a result, various aberrations can be corrected and the performance can be improved. By virtue of the fact that, in the case of such a configuration, it is possible to transform light with an arbitrary wavefront such as can also be generated with free-form surfaces, for example, the plurality of components having free-form surfaces, such as lens elements and/or mirrors, can be reduced.

The direction of incidence of the design wavefront for the at least two holographic elements of the holographic arrangement can be used as a degree of freedom in order to avoid filter effects between different wavelengths. The direction of incidence can also be chosen differently for each wavelength. Typically, the design wavefronts for the at least two wavelengths, typically for this the three wavelengths, are the same design wavefronts for each holographic element and differ only in the wavelength used.

The distance between the holograms and the thickness thereof are negligible compared with the dimension or the extent of the wavefront manipulator or of an optical arrangement including the wavefront manipulator. The holographic arrangement is therefore free of aberrations potentially caused by an extent in the direction of an optical axis. The design wavefronts of the holographic elements can furthermore be used as a degree of freedom for the compensation of material tolerances, for example for the compensation of material shrinkages. In this case, the general design wavefronts differ slightly from one another.

Typically, the at least two holographic elements are arranged at a distance from one another of less than one millimeter, in particular of less than 0.5 millimeters, typically of less than 0.1 millimeters. The distance is typically zero or negligible. As a result, firstly, a high imaging quality is achieved; additionally, the individual holographic elements do not have to be subsequently adjusted in regard to their position with respect to one another.

The holographic arrangement can be configured in the form of a layer or a film or a substrate, for example in the form of a volume hologram, or a plate. In addition or an alternative, the holographic arrangement can have a planar surface or a curved surface. The holographic arrangement can be arranged or have been arranged for example at or on a surface of a cover glass or of some other optical component that is present anyway. In this way, no additional installation space is taken up. For example, the wavefront manipulator can include an optical component configured to be transmissive and configured to be arranged in the beam path between the holographic arrangement and the projection surface. In this case, the holographic arrangement can typically be arranged at a surface—which faces away from the projection surfaces—of the optical component configured to be transmissive. Both the optical component fashioned to be transmissive and the holographic arrangement can be configured to be curved, typically with the same curvature. The aforementioned optical component fashioned to be transmissive can be a so-called glare trap, for example, which is usually arranged at a position between a windshield and a head-up display, and which is configured to reflect sunlight in a defined direction so that it is not reflected in the direction of the eyebox via the head-up display. In this configuration variant, the holographic arrangement and the glare trap are typically configured with the same curvature and arranged directly adjacent to one another.

Overall, the wavefront manipulator, by way of the holographic elements, enables a significantly larger or more extreme deflection of the used light than is possible with traditional refractive optical components. Moreover, high-quality multicolored images can be projected.

The picture generating device advantageously includes at least one plane, which is to say it is spatially extended, the plane being configured to emit light in a defined emission angle range and with a defined maximum bandwidth with regard to the wavelengths of the emitted light. Typically, each light-emitting point of the plane emits light in the form of a scattering lobe or in a defined angular range. This can be achieved for example by the use of a diffuser. Typically, the picture generating device is configured to emit laser light, in particular laser beams. Advantageously, the picture generating device is configured to emit laser light in at least two, typically at least three, different waves. That typically involves three different wavelengths of a defined color space, for example red, green and blue or cyan, magenta and yellow. Since the holographic elements are more sensitive with regard to the wavelength compared with other optical components, such as mirrors and lens elements, for example, it is advantageous if the picture generating device is configured with a defined maximum bandwidth with regard to the wavelengths of the emitted light.

The optical arrangement according to an aspect of the disclosure typically has a volume of less than 10 liters, which is to say in other words it occupies an installation space of less than 10 liters. It offers in particular a head-up display which is fashioned very compactly, which is to say occupies just a small installation space, and at the same time ensures a very high imaging quality in a plurality of image planes. The optical arrangement according to an aspect of the disclosure is suitable for retrofitting in for example motor vehicles, aircraft or VR arrangements, for example VR glasses.

In a further variant, the wavefront manipulator, in particular the at least one holographic arrangement, is configured to spectrally separate the images of the different image planes or to separate said images by generating different polarization states for the various image planes.

The picture generating device may include a plurality of picture generating units. In particular, a first picture generating unit may have the first region and a second picture generating unit may have the second region of the picture generating device. In other words, each picture generating unit can be configured to generate virtual images in a defined image plane. Such a configuration allows in particular simple and cost-effective retrofitting of existing head-up displays.

Further, the wavefront manipulator may include a plurality of holographic arrangements which are each configured to generate virtual images in a defined image plane. Likewise, the wavefront manipulator may include a plurality of optical elements which have a free-form surface and are configured to generate virtual images in at least a defined image plane. These variants also allow simple and cost-effective retrofitting of existing head-up display systems by way of suitable holographic arrangements and/or free-form elements in a cost-effective manner, in order to realize a head-up display with more than one image plane in different image distances.

The head-up display according to an aspect of the disclosure includes an above-described optical arrangement. It has the features and advantages already specified above. The projection surface can be a surface of a windshield of a vehicle or an observation window. The projection surface or the observation window may have a curved configuration. The vehicle may be a motor vehicle, an aircraft, a rail vehicle, or a ship. The observation window can be glasses, in particular smartglasses, a head-wearable transparent screen, AR glasses or an AR helmet, a visor or an eyepiece of a microscope.

The head-up display according to an aspect of the disclosure makes it possible to generate a virtual picture in a plurality of image planes and with a large field of view. For example, it is possible to generate rectangular virtual pictures which have a field of view of, for example, at least 10 degrees, typically at least 15 degrees times 5 degrees (FOV: 15°×5°), and are observable at specific distances away from the eyebox, for example at a distance of between 2 meters and 12 meters. The eyebox can have a dimension of up to 150 mm×150 mm.

The brightness and the uniformity of the virtual picture can be optimized by way of corresponding design waves of the holographic elements. Furthermore, the uniformity of the degree of whiteness can be set by setting of the factor of the color mixture, for example of the RGB color space in the picture generating unit.

### BRIEF DESCRIPTION OF THE DRAWINGS

The disclosure will now be described with reference to the drawings wherein:

FIG. 1 schematically shows the beam path of a head-up display with one image plane for a windshield of a motor vehicle in a side view,

FIG. 2 schematically shows the beam path of a head-up display with two image planes for a windshield of a motor vehicle in a side view according to an exemplary embodiment of the disclosure,

FIG. 3 schematically shows the beam path for different object planes with the same optical components,

FIG. 4 schematically shows the beam path for the same object plane with different optical components,

FIG. 5 schematically shows of a head-up display according to a first exemplary embodiment of the disclosure with an optical arrangement according to an exemplary embodiment of the disclosure,

FIG. 6 schematically shows a head-up display according to a second exemplary embodiment of the disclosure with an optical arrangement according to an exemplary embodiment of the disclosure,

FIG. 7 schematically shows a third embodiment variant of a head-up display according to the disclosure with an optical arrangement according to the disclosure,

FIG. 8 schematically shows a head-up display according to a fourth exemplary embodiment of the disclosure with an optical arrangement according to an exemplary embodiment of the disclosure,

FIG. 9 schematically shows a first variant of a holographic arrangement,

FIG. 10 schematically shows a second variant of a holographic arrangement, and

FIG. 11 schematically shows the beam path within the holographic arrangement.

### DESCRIPTION OF EXEMPLARY EMBODIMENTS

The disclosure is explained in larger detail below based on exemplary embodiments with reference to the accompanying figures. Although the disclosure is more specifically illustrated and described in detail with the exemplary embodiments, the disclosure is not restricted by the examples disclosed and other variations can be derived therefrom by a person skilled in the art, without departing from the scope of protection of the disclosure.

The figures are not necessarily accurate in every detail and to scale, and can be presented in enlarged or reduced form for the purpose of better clarity. For this reason, functional details disclosed here should not be understood as restrictive, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. If for example a composition containing the components A, B and/or C is described, the composition may contain A alone; B alone; C alone; A and B in combination; A and C in combination; B and C in combination; or A, B, and C in combination.

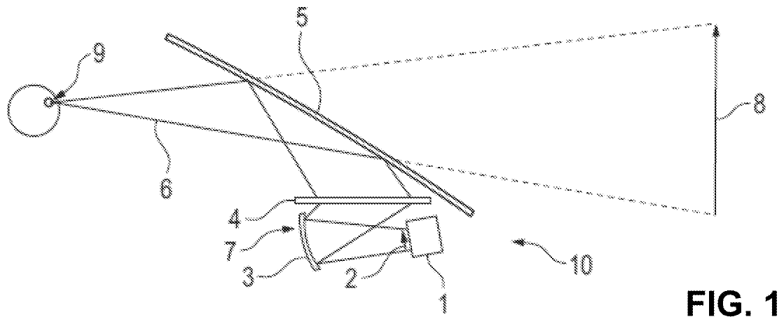

FIG. 1 schematically shows the beam path of a head-up display 10 with an image plane. The head-up display 10 includes a picture generating unit 1, a projection surface 5, for example in the form of a windshield of a motor vehicle, and a wavefront manipulator 7. The projection surface 5, for example the windshield, can be configured in curved fashion. In the case of an application for a vehicle, the picture generating unit 1 and the wavefront manipulator 7 are typically arranged in a manner integrated in a fitting (not shown). The head-up display 10 is configured such that it generates a virtual picture 8 on the projection surface 5, in particular on the surface of the windshield or in the external region of the vehicle, for example in the direction of travel behind the surface of the windshield. The beam path is identified by the reference sign 6.

In the configuration variant shown, the wavefront manipulator 7 includes a holographic arrangement 4 and an optical element 3 which is configured to be reflective and which has a free-form surface and is arranged in the beam path 6 proceeding from the picture generating unit 1 between the picture generating unit 1 and the holographic arrangement 4. The optical element 3 is typically configured as a free-form mirror.

The picture generating unit 1 emits light waves in the direction of the wavefront manipulator 7. The image information to be output or the picture generated by the picture generating unit 1 is identified by an arrow by the reference sign 2, while the virtual image thereof is identified by the reference sign 8. The wavefront manipulator 7 is used to correct imaging aberrations and optionally to expand the beam path. The wavefront manipulator 7 guides light waves in the direction of the projection surface 5, in particular the curved projection surface. At the projection surface 5, the light waves are reflected in the direction of an eyebox 9. In this case, the eyebox 9 forms the region in which a user must or can be located in order to be able to perceive the virtual image 8 generated by the head-up display 10. An image plane is defined by the image distance of the virtual image 8.

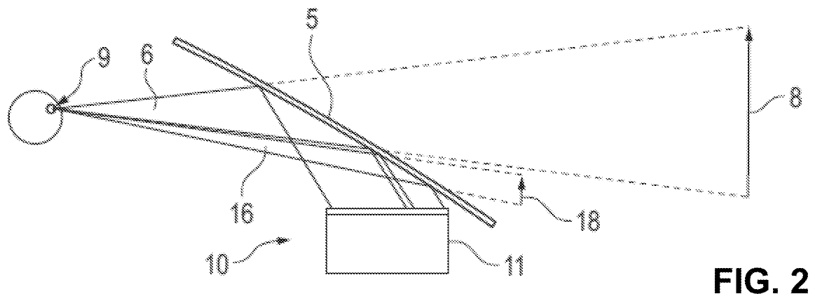

FIG. 2 schematically shows the beam path of a head-up display 10 according to an exemplary embodiment of the disclosure with two image planes, with the head-up display 10 including an optical arrangement 11 according to an exemplary embodiment of the disclosure. A first image plane corresponds to the image plane defined by the virtual image 8. A second image plane is defined by a further virtual image 18. The corresponding beam path is identified by the reference sign 16. The first image plane and the second image plane have deviating image distances. In this case, the beam paths 6 and 16 may have a spatial superposition.

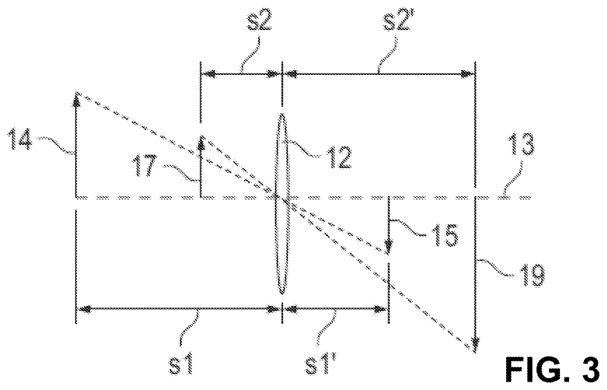

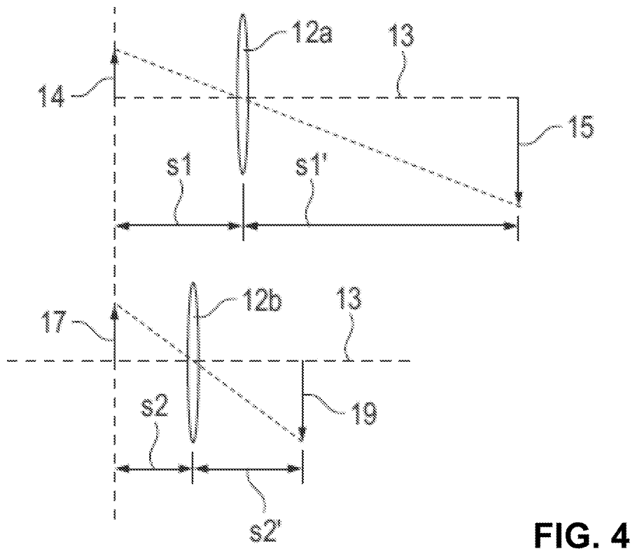

FIGS. 3 and 4 explain the optical principle on which the disclosure is based. If the optical system is considered in simplified fashion as a single lens element 12 with a focal length f and an optical axis 13, the imaging state between object (picture generator) 14, 17 and image (virtual picture) 15, 19 as depicted in FIG. 3 arises. FIG. 3 shows the beam path for images 15, 19 for different object distances or object spacings s1 and s2 with the same optical components 12. Two different image planes arise if the same system (only one focal length f) is used either for different object spacings (s1 and s2) or for different image spacings (s1′ and s2′). That is to say, it is not possible to realize two image spacings (s1′ and s2′) with a sufficient quality by way of a single optical system with the same object spacings (PGU).

Two different imaging systems 12a and 12b are needed if the same picture generator plane of the picture generating unit 1 is used for both virtual pictures 15 and 19. This means that the components 12a and 12b and the positions of the components 12a and 12b may be different, as depicted in FIG. 4. FIG. 4 shows the beam path of images for the same object plane with different optical components 12a and 12b.

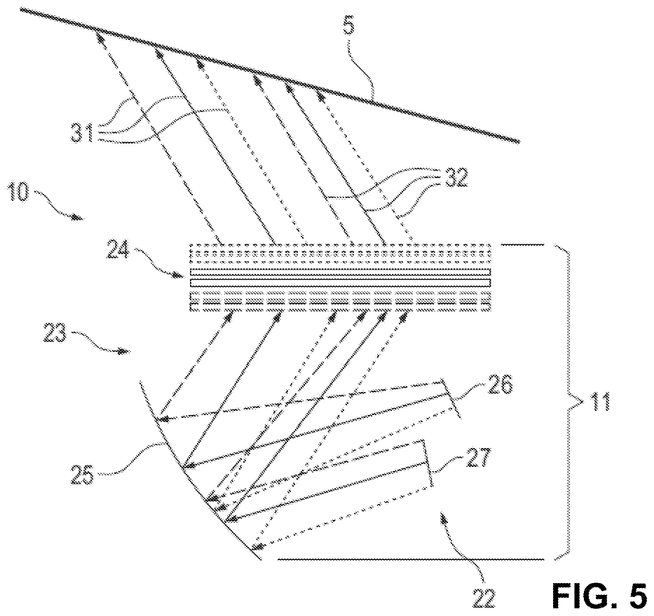

Embodiment variants of the present disclosure are explained in more detail below on the basis of FIGS. 5 to 8. FIGS. 5 to 8 each show a head-up display 10 according to an exemplary embodiment of the disclosure with an optical arrangement 11 according to an exemplary embodiment of the disclosure and a projection surface 5. The projection surface 5 can be a windshield or an observation window, for example.

The optical arrangement 11 in each case includes a picture generating device 22 and a wavefront manipulator 23 arranged in the beam path between the picture generating device 22 and the projection surface 5. In the variants shown, the wavefront manipulator 23 in each case includes a holographic arrangement 24 and at least one optical element 25 which has a free-form surface.

In the variant shown in FIG. 5, the various image planes are realized by two picture generating units 26 and 27, with the first picture generating unit 26 forming a first region of the picture generating device 22 and the second picture generating unit 27 forming a second region of the picture generating device 22. The first picture generating unit 26 and the second picture generating unit 27 have a respective picture generator plane or object plane, which differ from one another. In the variant shown, the picture generator plane of the second picture generating unit 27 is placed closer to the free-form element 25 than the picture generator plane of the first picture generating unit 26. In the variant shown in FIG. 5, the same holographic arrangement 24 and the same optical element 25, which is configured as a free-form mirror, are used for the two generated virtual image planes. Moreover, the wavelengths of the utilized color space, for example for red-green-blue (RGB), are identical for the two generated image planes. In the example shown, the rays of the beam path emanating from the first region 26 of the picture generating device 22 are identified by arrows with the reference sign 31 and the rays of the beam path emanating from the second region 27 of the picture generating device 22 are identified by arrows with the reference sign 32. Three wavelengths of a different color space can be used as an alternative to the RGB color space. A configuration with fewer than three different wavelengths, for example with only one or only two wavelengths, is also possible. As is evident from FIG. 5, a spatial superposition of the beam paths is possible.

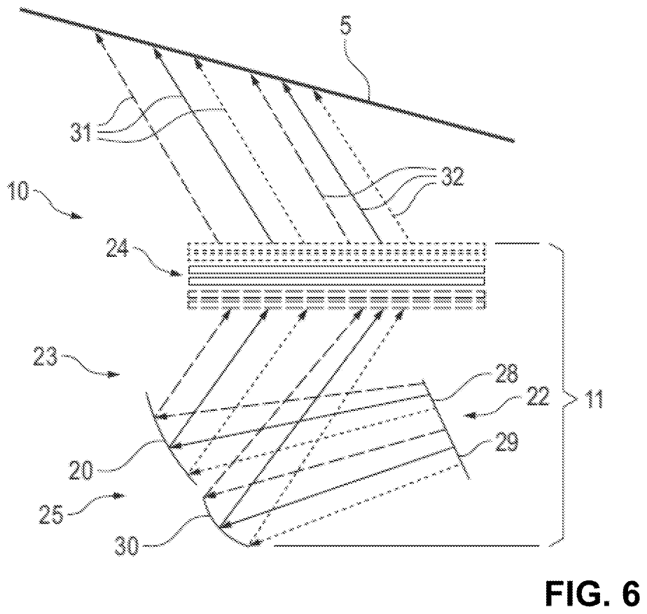

The variant shown in FIG. 6 differs from the variant shown in FIG. 5 in that only one picture generating unit is present in place of the two picture generating units. In this variant, the picture generating device 22 has a first region 28 and a second region 29, with the first region 28 emitting light rays for an image in a first image plane and the second region 29 emitting light rays for an image in a second image plane, which differs from the first image plane. The picture generating device 22 configured thus may for example include individual segments which are located in the same image generator plane but are configured for the generation of virtual images in different image planes.

In the variant shown in FIG. 6, the various image planes within the scope of the wavefront manipulator 23 are separated from one another by virtue of two different optical elements with free-form surfaces being present. Specifically, a first free-form mirror 20 and a second free-form mirror 30 are present, with the first free-form mirror 20 projecting light rays, which were sent by the first region 28, in the direction of the holographic arrangement 24 and the second free-form mirror 30 projecting light rays, which were emitted by the second region 29, in the direction of the holographic arrangement 24. As an alternative to the variant shown, it is possible to provide only one free-form surface 25 with correspondingly configured regions. In FIGS. 5 and 6, the three light rays of the first beam path 31 incident on the projection surface 5 to the left or higher up in the drawings are configured to generate a virtual image in a first image plane and the three light rays of the second beam path 32, shown in exemplary fashion, which are incident on the projection surface 5 to the right or further down in each case are configured to generate a virtual image in a second image plane that deviates from the first image plane.

To separate the beam paths at the free-form mirror 25 or the regions 20 and 30 in the variant shown in FIG. 6, the two virtual image planes must have a certain lateral spacing from one another perpendicular to the optical axis. For example, this means that the look down angle or the vertical image position for the field of view (FOV) for the image plane must be chosen to be larger than in the variant shown in FIG. 5. In this case, the two beam paths can be corrected by different free-form mirrors 20 and 30. In this way, it is possible to realize two deviating image planes. The image generator planes or object planes for the two virtual pictures may be arranged on the same picture generator area, but also in different parts or regions, for example above or below one another or laterally next to one another.

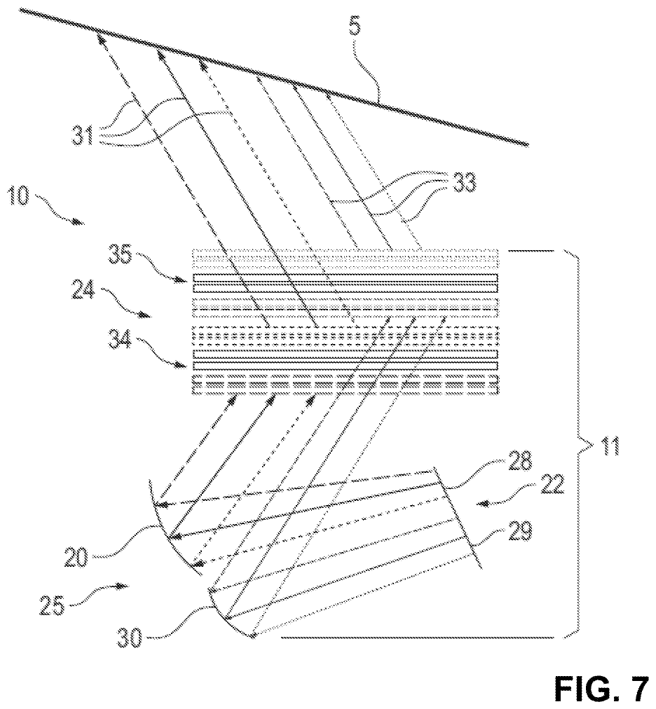

The variant shown in FIG. 7 differs from the variant shown in FIG. 6 in that, firstly, the two regions 28 and 29 of the picture generating device are configured to emit deviating light waves and that the wavefront manipulator 23 includes a first holographic arrangement 34 and a second holographic arrangement 35. In this case, the first holographic arrangement 34 is configured to generate virtual images in the first image plane from pictures generated in the first region 28 of the picture generating device 22, and the second holographic arrangement 35 is configured to generate virtual images in the second image plane from pictures generated in the second region 29 of the picture generating device 22.

The light of a first color 31 emitted by the first region 28 has a wavelength that differs from light of a first color 36 emitted by the second region 29 by a wavelength difference which exceeds a defined limit value, for example by more than 10 nanometers. The light 31 and 36 can be red light. The light of a second color 32 emitted by the first region 28 has a wavelength that differs from light of a second color 37 emitted by the second region 29 by a wavelength difference which exceeds a defined limit value, for example by more than 10 nanometers. The light 32 and 37 can be green light. The light of a third color 33 emitted by the first region 28 has a wavelength that differs from light of a third color 38 emitted by the second region 29 by a wavelength difference which exceeds a defined limit value, for example by more than 10 nanometers. The light 33 and 38 can be blue light. The first region 28 and the second region 29 can also be configured to emit light from deviating color spaces; for example, the first region 28 can be configured to emit light from the RGB color space and the second region 29 can be configured to emit light from the CMY color space.

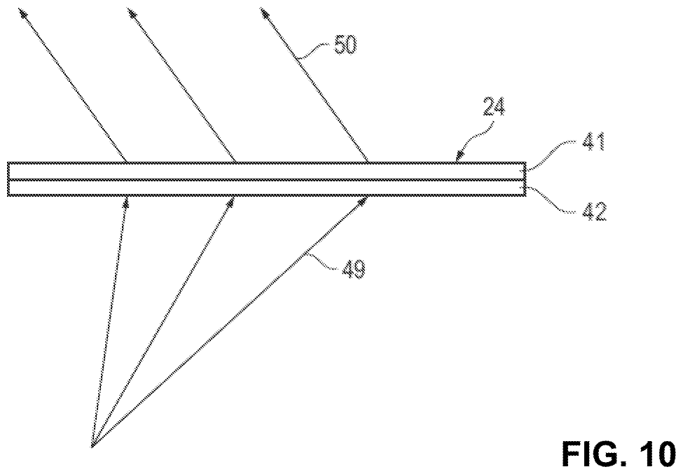

Typically, the first holographic arrangement 34 is not efficient for diffracting light emitted by the second region 29, and the second holographic arrangement 35 is not efficient for the light emitted by the first region 28. The wavelengths emitted by the various regions are therefore chosen to be different for the two virtual image planes. By preference, two wavelength triplets of a defined color space, for example red, green, and blue, are selected, said wavelength triplets differing from one another depending on the region from which they are emitted. For example, the first region 28 can emit red light at a wavelength that differs by a defined absolute difference value from the red light emitted by the second region 29. In the variant shown, the two holographic arrangements 34 and 35 are arranged successively in the beam path. In principle, an arrangement next to one another is also possible. In an alternative, the gratings of the two wavelengths of an associated color can be written into the same hologram, which is to say the two blue holograms of the two holographic arrangements 34 and 35 can be written or exposed in two holograms (blue multiplex holograms) of a joint holographic arrangement. Analogously to the example shown in FIG. 10 there may be a plurality of multiplex holograms present, for example an RR′ hologram, a GG′ hologram, and a BB′ hologram (i.e., 6 holograms as a stack) or any other suitable combination. This can reduce the number of holographic arrangements without restricting the functionality.

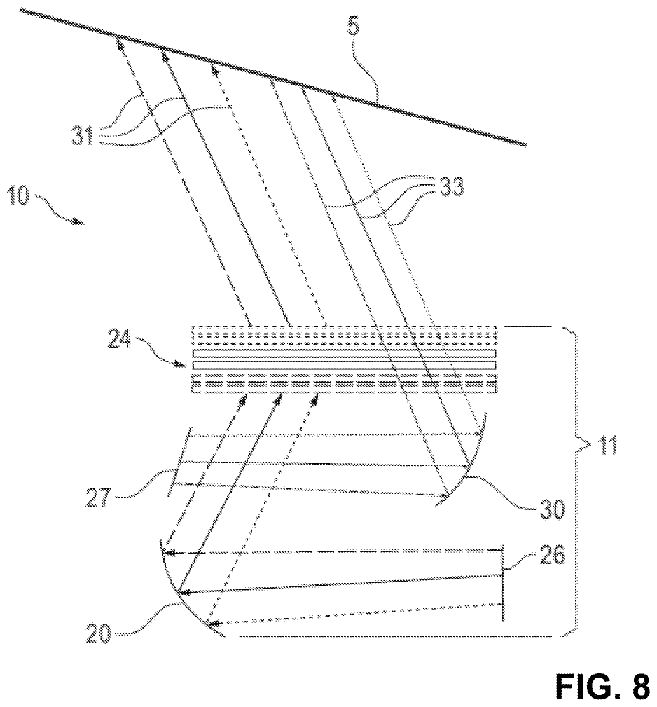

The embodiment variant shown in FIG. 8 combines various variants that have already been explained based on FIGS. 5 to 7. Two different picture generating units 26 and 27 are present and are positioned such that their image generator planes differ from one another. Moreover, the wavelengths emitted by the two picture generating units 26 and 27 differ by a defined minimum absolute value. The light emitted by the first picture generating unit 26 is reflected in the direction of the holographic arrangement 24 with a first free-form mirror 20. The light emitted by the second picture generating unit 27 is reflected through the holographic arrangement 24 or past the latter in the direction of the projection surface 5 with a second free-form mirror 30. In the variant shown in FIG. 8, the holographic arrangement 24 is only efficient for diffracting light wavelengths emitted by the first picture generating unit 26. The light emitted by the second picture generating unit 27 has wavelengths that are not efficiently diffracted by the holographic arrangement 24. This means that only one free-form surface 30 is used for the light shaping of the light 33 emitted with the second picture generating unit 27. By contrast, a free-form surface 20 and a holographic arrangement 24 matched to the wavelengths are used for the beam path 31 of the light emitted by the picture generating device 26.

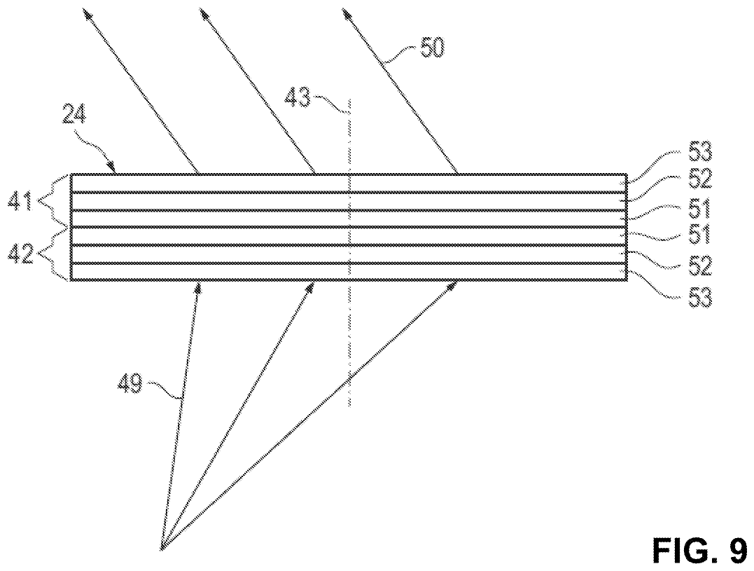

Below, variants for a configuration of suitable holographic arrangements 24 are explained based on FIGS. 9 to 11.

The holographic arrangement 24 shown in FIG. 9 includes a first holographic element 41 and a second holographic element 42. In the exemplary embodiment variant shown, the first holographic element 41 and the second holographic element 42 each have three monochromatic holograms arranged one on top of another, of which by way of example a hologram recorded with red light is identified by the reference numeral 51, a hologram recorded with green light is identified by the reference numeral 52 and a hologram recorded with blue light is identified by the reference numeral 53. The first holographic element 41 and the second holographic element 42 are arranged against one another in such a way that the individual holograms are arranged mirror-symmetrically with respect to one another. In the variant shown, the holograms 51 recorded with red light are arranged directly adjacent to one another. The first holographic element 41 and the second holographic element 42 can be directly adjacent to one another or can be arranged at a negligible distance from one another, typically at a distance of less than 1 millimeter.

In FIGS. 9 and 10, the incident light waves in the form of beams are identified by arrows with the reference numeral 49 and the beam path of the light leaving the holographic arrangement 24 is identified by arrows with the reference numeral 50. In the variant shown in FIG. 9, the individual, mutually differing holograms 51, 52 and 53 of the individual holographic elements 41 and 42 are arranged one behind another in relation to a center line or center axis 43, which can be an optical axis, along the latter. Individual, mutually differing holograms 51, 52 and 53 of the individual holographic elements 41 and 42 can also be arranged laterally with respect to one another in relation to a center line or center axis 43.

FIG. 10 shows a further exemplary embodiment variant of a wavefront manipulator 24 according to an aspect of the disclosure. In a departure from the variant shown in FIG. 9, the first holographic element 41 and the second holographic element 42 each include only one hologram, which however is recorded in each case with light having a plurality of different wavelengths. The variant shown involves two RGB holograms by way of example. The holograms have for example hologram grating structures produced with red light, hologram grating structures recorded with green light and hologram grating structures recorded with blue light.

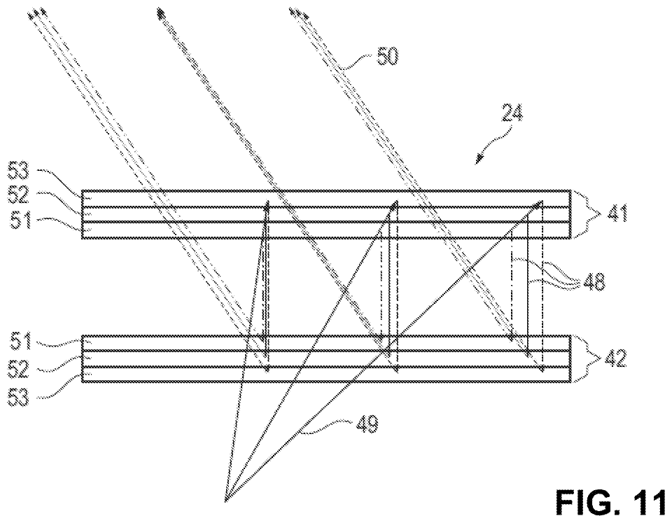

FIG. 11 schematically shows the beam path within the holographic arrangement 24. For illustration purposes, here the first holographic element 41 and the second holographic element 42 are arranged at a distance from one another. However, this only serves to illustrate the beam path. In this case, the incident light 49 is reflected at the individual holograms 51-53 or the hologram grating structures 51-53 wavelength-specifically for specific angle of incidence ranges, which is to say blue light with a specific angle of incidence at the holograms 53 recorded with blue light, green light in a specific angle of incidence range at the holograms 52 recorded with green light, and red light correspondingly at the holograms 51 recorded with red light. In the variant shown, incident light 49 is firstly transmitted through the second holographic element 42 and is reflected at the first holographic element 41. The light 48 reflected by the first holographic element 41 is reflected at the second holographic element 42 and forms the wavefront 50 leaving the holographic arrangement.

The first holographic element 41 is configured such that it transforms a spherical wave into a plane wave. As a result, the holographic element 24 has a high refractive power, without the volume and thus the required installation space being increased. Furthermore, the beam cross section on the mirror decreases, as a result of which both the size and the refractive power of the mirror can be reduced. This is additionally advantageous since the refractive powers can be better distributed in the system and the latter becomes less sensitive to tolerances. The wavefront 48 transmitted is typically plane. The filter effect between the wavelengths is minimized as a result. Moreover, this relaxes the positioning accuracy of the holographic elements 41 and 42 with respect to one another in the lateral direction. In comparison with conventional components the first holographic element 41 acts like a concave mirror and the second holographic element 42 acts like a plane mirror. Overall, the holographic arrangement 24, in particular the hologram stack consisting of the first holographic element 41 and the second holographic element 42, has the function of a positive lens but with minimal volume.

It is understood that the foregoing description is that of the exemplary embodiments of the disclosure and that various changes and modifications may be made thereto without departing from the spirit and scope of the invention as defined in the appended claims.

### LIST OF REFERENCE NUMERALS

1 Picture generating unit
2 Image information to be output
3 Optical element with a free-form surface
4 Holographic arrangement
5 Projection surface
6 Beam path
7 Wavefront manipulator
8 Virtual image, image plane
9 Eyebox
10 Head-up display
11 Optical arrangement
12 Lens element
13 Optical axis
14 Object
15 Image
16 Beam path 1
17 Object
18 Virtual image, image plane
19 Image
20 Free-form mirror
22 Picture generating device
23 Wavefront manipulator
24 Holographic arrangement
25 Optical element with a free-form surface
26 Picture generating unit
27 Picture generating unit
28 First region
29 Second region
30 Free-form mirror
31 Beam path
32 Beam path
33 Beam path
34 First holographic arrangement
35 Second holographic arrangement
41 First holographic element
42 Second holographic element
43 Center line
48 Beam path
49 Beam path
50 Beam path
51 Hologram recorded with red light
52 Hologram recorded with green light
53 Hologram recorded with blue light
s1 Object distance
s2 Object di stance
s1′ Image di stance
s2′ Image distance

What is claimed is:

1. An optical arrangement for a head-up display on a projection surface, the optical arrangement comprising:
a picture generating device, which includes at least one picture generating unit; and
at least one wavefront manipulator arranged in a beam path between the picture generating device and the projection surface,
wherein the optical arrangement is configured to generate virtual images in at least two different image planes,
wherein the picture generating device has at least a first region and a second region, and
wherein the picture generating device and the wavefront manipulator are configured in combination with one another to generate virtual images in a first image plane from pictures generated in the first region of the picture generating device and to generate virtual images in a second image plane from pictures generated in the second region of the picture generating device.

2. The optical arrangement as claimed in claim 1, wherein the first region and the second region of the picture generating device have a common picture generator plane, or
wherein the first region of the picture generating device has a first picture generator plane and the second region of the picture generating device has a second picture generator plane, and wherein the first picture generator plane and the second picture generator plane differ from one another.

3. The optical arrangement as claimed in claim 1, wherein the at least one wavefront manipulator includes at least one holographic arrangement and/or at least one optical element which has a free-form surface.

4. The optical arrangement as claimed in claim 3, wherein the at least one holographic arrangement is configured to diffract light at a plurality of wavelengths.

5. The optical arrangement as claimed in claim 3, wherein the wavefront manipulator includes at least a first holographic arrangement and a second holographic arrangement, and
wherein the first holographic arrangement is configured to generate virtual images in the first image plane from pictures generated in the first region of the picture generating device and the second holographic arrangement is configured to generate virtual images in the second image plane from pictures generated in the second region of the picture generating device.

6. The optical arrangement as claimed in claim 5, wherein the first holographic arrangement is configured to diffract light at at least a first wavelength,
wherein the second holographic arrangement is configured to diffract light at at least a second wavelength, and
wherein a difference between the first and the second wavelength exceeds a defined limit value.

7. The optical arrangement as claimed in claim 3, wherein the at least one holographic arrangement and/or the at least one optical element are configured to be reflective and/or transmissive.

8. The optical arrangement as claimed in claim 3, wherein the at least one holographic arrangement includes at least two holographic elements arranged directly in succession in the beam path.

9. The optical arrangement as claimed in claim 3, wherein the at least one holographic arrangement includes at least two holographic elements configured to be reflective for at least a defined wavelength and a defined angle of incidence range.

10. The optical arrangement as claimed in claim 3, wherein the at least one holographic arrangement includes at least two holographic elements,
wherein at least one holographic element includes a plurality of holograms arranged one on top of another as a stack, or
wherein at least a holographic element includes at least one hologram recorded with at least two defined wavelengths.

11. The optical arrangement as claimed in claim 1, wherein the wavefront manipulator is configured to spectrally separate images of the different image planes or to separate the images by generating different polarization states for various image planes.

12. The optical arrangement as claimed in claim 1, wherein the picture generating device includes a plurality of picture generating units.

13. The optical arrangement as claimed in claim 1, wherein the wavefront manipulator includes a plurality of holographic arrangements which are each configured to generate virtual images in a defined image plane.

14. The optical arrangement as claimed in claim 1, wherein the wavefront manipulator includes a plurality of optical elements which have a free-form surface and which are each configured to generate virtual images in at least a defined image plane.

15. The head-up display, comprising:
a projection surface; and
an optical arrangement as claimed in claim 1.

16. The head-up display as claimed in claim 15, wherein the projection surface is a surface of a windshield of a vehicle or an observation window.
